(19) United States
(12) Patent Application Publication
(10) Pub. No.: US 2025/0259096 A1
(43) Pub. Date: Aug. 14, 2025

(54) DOMAIN-SPECIFIC WORD EMBEDDING MODEL

(71) Applicant: Microsoft Technology Licensing, LLC, Redmond, WA (US)

(72) Inventor: Manikanta KOTARU, Kenmore, WA (US)

(73) Assignee: Microsoft Technology Licensing, LLC, Redmond, WA (US)

(21) Appl. No.: 18/437,975

(22) Filed: Feb. 9, 2024

(51) Int. Cl. G06N 20/00

(52) U.S. Cl. CPC G06N 20/00

(57) ABSTRACT

Despite the usefulness of foundation models, they often return irrelevant or inaccurate responses to domain-specific queries, which often include technical jargon and patterns that are unique to the domain. Training data for specialized domains is not readily accessible or frequently discussed in online forums, so foundation models lack understanding in specialized domains. Moreover, while the embedding models underlying foundation models may be finetuned using annotated datasets, generating these datasets for niche and specialized domains is an extremely arduous, time-consuming, and expensive task. These issues are overcome by implementing a generative pseudo labeling (GPL) approach to creating labeled data for finetuning embedding models to recognize semantic similarities for specialized domains. In this way, the accuracy and relevance of foundation-model responses to domain-specific queries is improved.

### BACKGROUND

With the advent of 5G, Multi-access Edge Computing (MEC) has become important to improve performance of cloud services. In MEC, a hierarchy of devices, datacenters and servers is used to provide cloud computing capabilities and information technologies at the edge of a radio access network (RAN), such as 5G. However, the complexity of technical specifications in this niche field presents a formidable challenge in understanding, developing, researching, or modifying modern wireless communication technologies. Researchers, practitioners, engineers, and students can find themselves grappling with unfamiliar acronyms, intricate terminology, and information spread across a vast number of documents. Traditionally, acquiring this type of information involved painstakingly sifting through webpages and technical specifications. With emergence of foundation models (e.g., ChatGPT), operators can pose natural language queries to return synthesized, readily comprehensible answers related to wireless communication specifications and technologies. However, despite the usefulness of foundation large language models (LLMs), they offer irrelevant or inaccurate responses to many of these queries.

It is with respect to these and other general considerations that embodiments have been described. Also, although relatively specific problems have been discussed, it should be understood that the embodiments should not be limited to solving the specific problems identified in the background.

### SUMMARY

Aspects of the present application relate to developing a domain-specific word embedding model that can better interpret specialized terminologies and jargon and model semantic relationships specific to niche domains. The model is developed by finetuning an existing embedding model with data from technical specifications within a specialized domain. In examples described herein, an off-the-shelf embedding model is finetuned with pseudo-labeled question-answer pairs based on telco specifications, such as 3GPP specifications, WiFi standards, and Open Radio Access Network (O-RAN) specifications. However, the same or similar finetuning of an embedding model may be achieved for other niche domains, such as chemical, biomedical, aeronautical, governmental, aerospace, and the like.

As noted above, foundation models perform poorly when queried about highly specialized information. This deficiency is largely due to the fact that LLMs are typically trained on a massive corpus of web data that covers a broad range of topics and domains. This training data is designed to capture the linguistic patterns and structures of natural language, enabling the models to generate coherent and contextually appropriate responses to a wide range of queries. However, domain-specific queries often require specialized training data to capture the technical jargon and patterns that are unique to the domain. Unfortunately, such training data is not always readily accessible or frequently discussed in online forums. This makes it challenging for LLMs to identify the relevant patterns and generate contextually appropriate responses. As a result, the responses generated by these models may be incomplete or irrelevant.

To address the above challenges, a context extractor may be utilized to identify text samples in a domain-specific database that are most relevant to answering a user query and provide them as supplemental context to the foundation model. For example, a word embedding model may be used to convert both the user's query and each of the text samples in the domain-specific database into word embedding vectors. The relevancy of a text sample to the user query is determined based on a semantic similarity between the corresponding embedding vectors. Similar to LLMs generally, embedding models are generally trained on a vast corpus of web data containing regular language text. However, specialized technical documents are filled with unique terminologies, acronyms, and specialized jargon that are not well represented in regular language. Accordingly, existing word embedding models fail to capture the semantic similarity of many words and sentences that are specific to niche domains and are not discussed widely in online forums. Embedding models may be finetuned using annotated datasets containing pairs of text with corresponding similarity scores; however, generating annotated datasets for niche and specialized domains is an extremely arduous, time-consuming, and expensive task—often requiring experts. Accordingly, the present application describes a generative pseudo labeling approach to creating labeled data for finetuning an existing embedding model to recognize semantic similarities within a specialized domain.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which one or more foundation models may be used in a telco domain, according to aspects of the present disclosure.

FIG. 2A illustrates an overview of an example conceptual architecture for finetuning an embedding model to better recognize semantic similarities in domain-specific text, according to aspects described herein.

FIG. 2B illustrates an overview of an example conceptual architecture for using one or more ML models to increase answer accuracy for domain-specific queries, according to aspects described herein.

FIG. 2C illustrates an overview of recall test results for identifying the correct source segment for a given domain-specific question as a function of the number of training (finetuning) steps, according to aspects described herein.

FIG. 3 illustrates an overview of an example method 300 for finetuning an embedding model, according to aspects described herein.

FIG. 4 illustrates an overview of an example method 400 for using a foundation model to output an answer to a domain-specific query, according to aspects described herein.

FIGS. 5A and 5B illustrate overviews of an example generative machine learning model that may be used according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present application relates to developing a domain-specific word embedding model that can better interpret specialized terminologies and jargon and model semantic relationships specific to niche domains. The model is developed by finetuning an existing embedding model with data from technical specifications within a specialized domain. In examples described herein, an off-the-shelf embedding model is finetuned with pseudo-labeled question-answer pairs based on telco specifications, such as 3GPP specifications, WiFi standards, and Open Radio Access Network (O-RAN) specifications. However, the same or similar finetuning of an embedding model may be achieved for other niche domains, such as networking, space communications, quantum computing, and the like.

As an example, the complexity of technical specifications presents a formidable challenge in understanding, developing, researching, or modifying modem wireless communication technologies. Researchers, practitioners, engineers, and students can find themselves grappling with unfamiliar acronyms, intricate terminology, and information spread across a vast number of documents. For example, an engineering team working on implementing a registration request procedure as a part of building 5G virtual core would need to identify all of the relevant technical specifications from among thousands of such documents, as well as understanding the call flow and message formats as described in those specifications. Traditionally, acquiring this type of information involved painstakingly sifting through webpages and technical specifications. With emergence of foundation models (e.g., ChatGPT), operators can pose natural language queries to return synthesized, readily comprehensible answers related to wireless communication specifications and technologies. However, despite the usefulness of state-of-the-art foundation large language models (LLMs), they offer irrelevant or inaccurate responses to many of these queries. For example, in response to the query, “what is numerology in 5G,” a modern foundation model returns a discussion of numerology as related to the mystical significance of numbers, which has no connection to 5G. Similarly, when prompted about “the number of unique values physical identity can take in 5G,” it responds that “PCI consists of a 3-bit value ranging from 0 to 503,” which is both inaccurate and non-sensical as a 3-bit value cannot take 504 different values.

As noted above, foundation models perform poorly when queried about highly specialized information. This deficiency is largely due to the fact that LLMs are typically trained on a massive corpus of web data that covers a broad range of topics and domains. This training data is designed to capture the linguistic patterns and structures of natural language, enabling the models to generate coherent and contextually appropriate responses to a wide range of queries. However, domain-specific queries, like those related to wireless communication specifications, often require specialized training data to capture the technical jargon and patterns that are unique to the domain. Such training data is not always readily accessible. For example, 3GPP Release 16 consists of thousands of technical specifications spread across multiple compressed zip folders stored on a file transfer protocol (FTP) site. Further, wireless specifications are not frequently discussed in online forums. This makes it challenging for LLMs to identify the relevant patterns and generate contextually appropriate responses. As a result, the responses generated by these models may be incomplete or irrelevant.

To address the above challenges, a context extractor may be utilized to identify text samples in a domain-specific database that are most relevant to answering a user query and provide them as supplemental context to the foundation model for answering the user query. For example, a word embedding model is used to convert both the user's query and each of the text samples in the domain-specific database into word embedding vectors. The relevancy of a text sample to the user query is determined based on a semantic similarity measured in terms of a similarity metric, e.g., cosine similarity, L2-distance, or similar distance metric, between the corresponding embedding vectors. Using such similarity metric, the samples in the database are ranked according to their similarity to the user query and the most similar samples are then used as supplemental context to the user query in a to the foundation model.

Similar to LLMs generally, embedding models are trained on a vast corpus of web data containing regular language text. Thus, word embedding models are trained to model the similarity between words that are semantically close in regular usage, e.g., the words ‘rain’ and ‘umbrella’ are identified as semantically close to each other. However, specialized technical documents, such as wireless standards, are filled with unique terminologies, acronyms, and specialized jargon that are not well represented in regular language. Accordingly, existing word embedding models fail to capture the semantic similarity of many words and sentences that are specific to niche domains and are not discussed widely in online forums. For example, although “N6 interface” and “User Plane Function” should be identified as semantically close within the wireless domain, existing word embedding models are unable to capture this semantic similarity. Embedding models may be finetuned using annotated datasets containing pairs of text with corresponding similarity scores; however, generating annotated datasets for niche and specialized domains is an extremely arduous, time-consuming, and expensive task—often requiring experts. Accordingly, the present application describes a generative pseudo labeling (GPL) approach to creating labeled data for finetuning an existing embedding model to recognize semantic similarities within a specialized domain.

To implement the GPL, a domain-specific database is segmented along section boundaries to maintain coherence and preserve meaning of the content segments. The content segments are then fed to a foundation model (or a specially trained question-generation model such as T5-base model) to generate a plurality of questions based on each content segment. The source content segment paired with each generated question of the plurality of generated questions is referred to herein as a “positive question/answer (Q/A) pair” (or positive semantic pair) and is assigned a high similarity score (e.g., “1”). Each generated question is then fed into an embedding model, which converts the generated question into a word embedding, and a context extractor, which compares the word embedding of the question to word embeddings of the content segments and returns the top-K (e.g., top 10) content segments relevant to the generated question based on semantic similarity. Of the top-K results, the Q/A pair including the source content segment is assigned a high similarity score (e.g., “1”) (e.g., positive semantic pair), while the remaining Q/A pairs are assigned a low similarity score (e.g., “0”) (e.g., negative semantic pairs). In this way, the positive semantic pair is biased toward semantic similarity since it includes the source content segment, whereas the remaining negative semantic pairs are biased away from semantic similarity. These pseudo-labeled semantic pairs are then used to finetune the embedding model to recognize domain-specific patterns and semantic similarities that would not otherwise be identified based on regular language usage. In similar fashion, upon receipt of a domain-specific user query, the finetuned embedding model converts the user query into a word embedding. However, in this case, the finetuned embedding model is better able to incorporate domain-specific semantics into the word embedding. The context extractor compares the word embedding of the user query to word embeddings of the content segments (also generated by the finetuned embedding model) and returns the top-K (e.g., top 10) content segments based on semantic similarity. The context extractor then compiles the results and feeds them as context with the user query to a foundation model. In this way, the foundation model is able to overcome the challenges described above and generate contextually accurate responses to a domain-specific query.

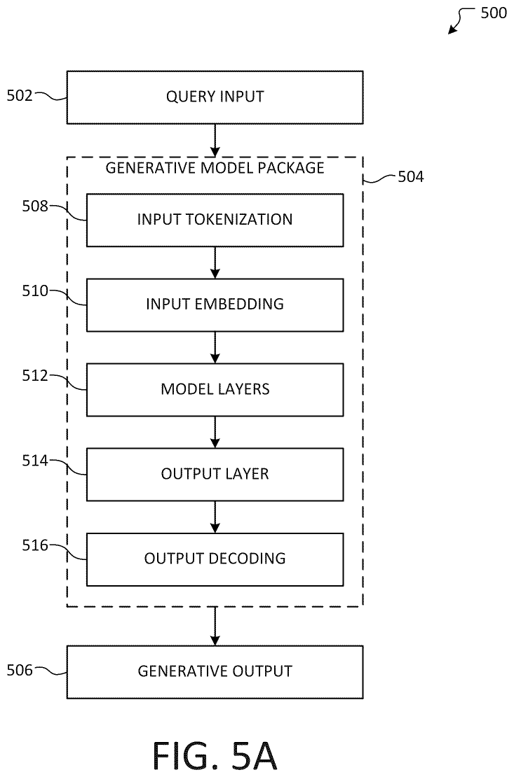

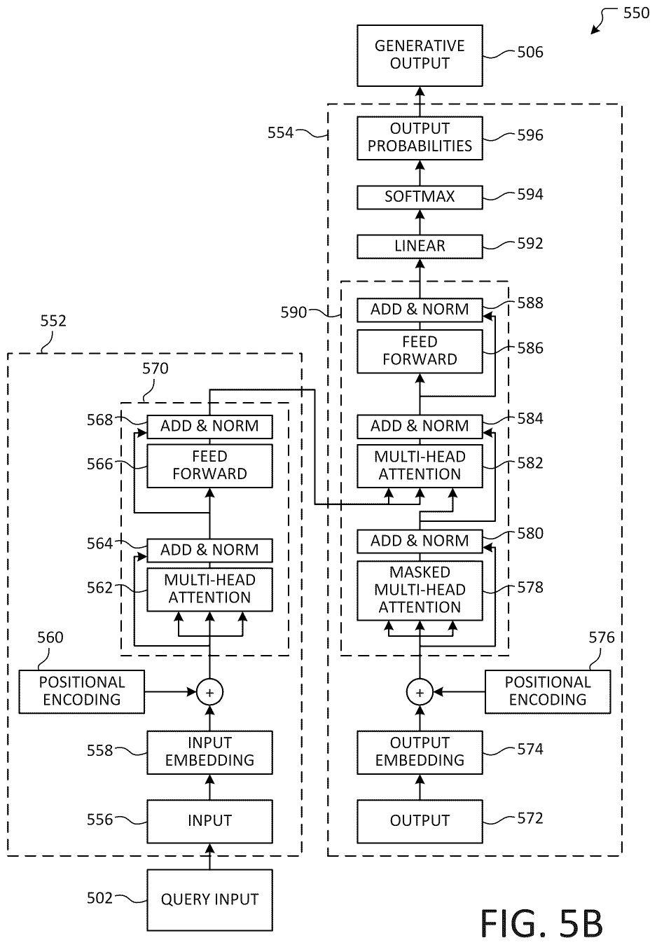

In examples, a generative model (also generally referred to as a foundation model) may be used according to aspects described herein and may generate any of a variety of output types (and may thus be a multimodal generative model, in some examples). For example, the generative model may include a generative transformer model and/or a large language model (LLM), a generative image model, or the like. Example models include, but are not limited to, Megatron-Turing Natural Language Generation model (MT-NLG), Generative Pre-trained Transformer 3 (GPT-3), Generative Pre-trained Transformer 3.5 turbo (GPT-3.5-turbo), Generative Pre-trained Transformer 4 (GPT-4), BigScience BLOOM (Large Open-science Open-access Multilingual Language Model), DALL-E, DALL-E 2, Stable Diffusion, Text-Curie-001, or Jukebox. Additional examples of such aspects are discussed below with respect to the generative ML model illustrated in FIGS. 5A-5B. Examples of existing embedding models include but are not limited to sentence-BERT (e.g., s-BERT all-MiniLM-L6-v2 or msmarco-distilbert-base-dot-prod-v3), CPU-optimized and quantized modes (e.g., ggml-all-MilniLM-L6-v2-f16), Word2Vec, S-RoBERTa, GloVe, FastText, CoVe, ELMO, and the like.

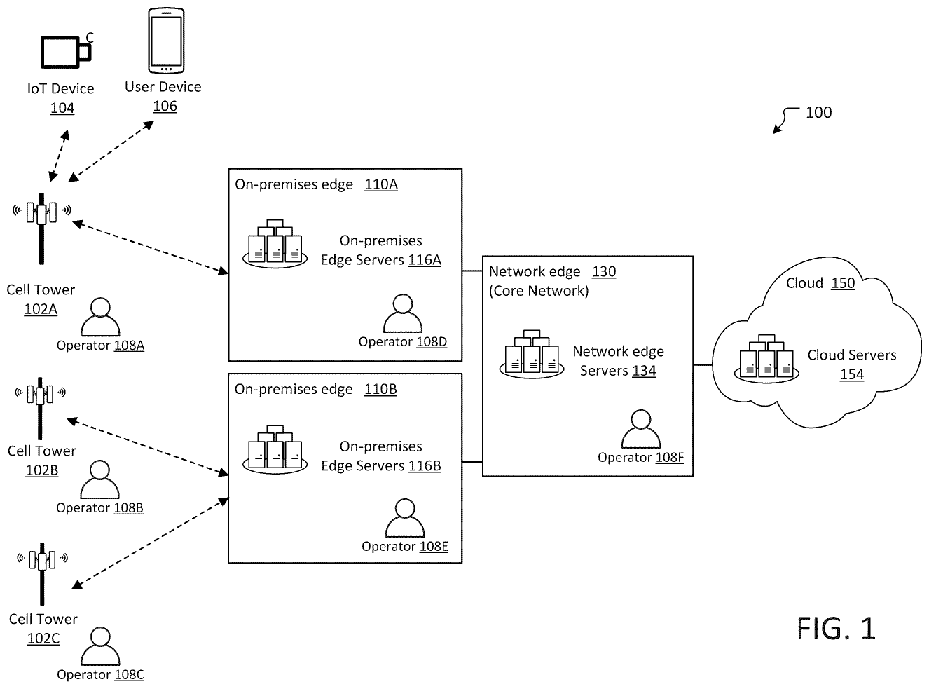

FIG. 1 illustrates an overview of an example system 100 in which one or more foundation models may be used in a telecommunications (telco) domain, according to aspects of the present disclosure. Cell towers 102A-C transmit and receive wireless communications with user device(s) 106 (e.g., mobile device, PDA, laptop computer, watch, etc.), IoT device(s) 104 (e.g., video cameras, health monitors, appliances, etc.), and other wireless-enabled devices, over a telecommunications (telco) network. In aspects, one or more operators 108A-F may manage the one or more cell towers 102A-C. The example system 100 further includes on-premises edges 110A-B (including edge servers 116A-B), a network edge 130 (including core network servers 134), and a cloud 150 (including cloud servers 154 responsible for providing cloud services). In aspects, example system 100 corresponds to a cloud RAN infrastructure for a mobile wireless telecommunication network.

As noted above, in Multi-access Edge Computing (MEC), a hierarchy of devices, datacenters and servers with varying levels of resource availability and geographic locality is used to provide cloud computing capabilities and information technologies at the edge of a radio access network (RAN), such as 5G. The term “on-premises edge” may refer to a server or datacenter at a remote location at the far-edge of a private cloud, which may be in proximity to one or more cell towers. The “network edge” may refer to distributed servers and datacenters implementing a core network at the near-edge of a private cloud. The RAN, in combination with a core network of a cloud service provider, represents a backbone network for mobile wireless telecommunications. For example, cell towers may receive and transmit radio signals to communicate with user devices (e.g., mobile phones) or IoT devices (e.g., video cameras) over a RAN (e.g., 5G), which may utilize cloud services for data analytics, information technologies, or other services. Various service applications implemented by MEC may perform different functions, such as network monitoring and management.

As illustrated, the on-premises edges 110A-B (or “on-prem” edges 110A-B) are datacenters that enable cloud integration with a radio access network (RAN). The on-prem edges 110A-B include on-prem edge servers 116A-B, which process incoming and outgoing data traffic from the cell towers 102A-C. In aspects, the on-premises edges 110A-B are generally geographically remote from the datacenters associated with the core network (e.g., network edge 130) and cloud services (e.g., cloud 150). The remote site is in geographic proximity to respective cell towers 102A-C. For example, the proximity may be within about a few kilometers. As illustrated, the on-premises edge 110A is in proximity to the cell tower 102A and the on-premises edge 110B is in proximity to the cell towers 102B-C. In some aspects, the same or different operators 108A-E may manage on-premises edges 110A-B and cell towers 102A-C.

The on-prem edge servers 116A-B may execute service applications, which may include any number of network monitoring or management functions. To process operator queries (e.g., a NL query by operator 108D managing on-premises edge server 116A), service applications may further implement or access domain-specific databases, embedding models, context extractors, and/or foundation models. In other cases, based on the limited resources available on the on-prem edges 110A-B, these functions may be performed upstream on the network edge 130 or cloud 150.

While FIG. 1 is described with reference to a cloud RAN architecture, other specialized domains could similarly implement the technology described herein, e.g., using one or more domain-specific databases, embedding models, context extractors, and/or foundation models to respond to domain-specific queries. As will be appreciated, the various methods, devices, applications, features, etc., described with respect to FIG. 1 are not intended to limit the system 100 to being performed by the particular applications and features described. Accordingly, additional configurations may be used to practice the methods and systems herein and/or features and applications described may be excluded without departing from the methods and systems disclosed herein.

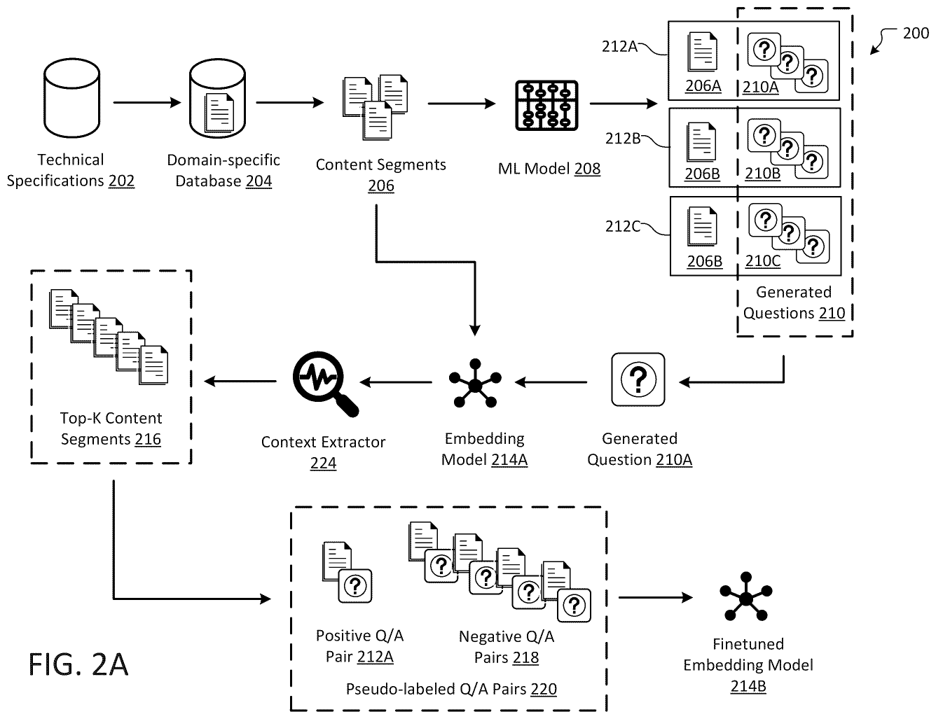

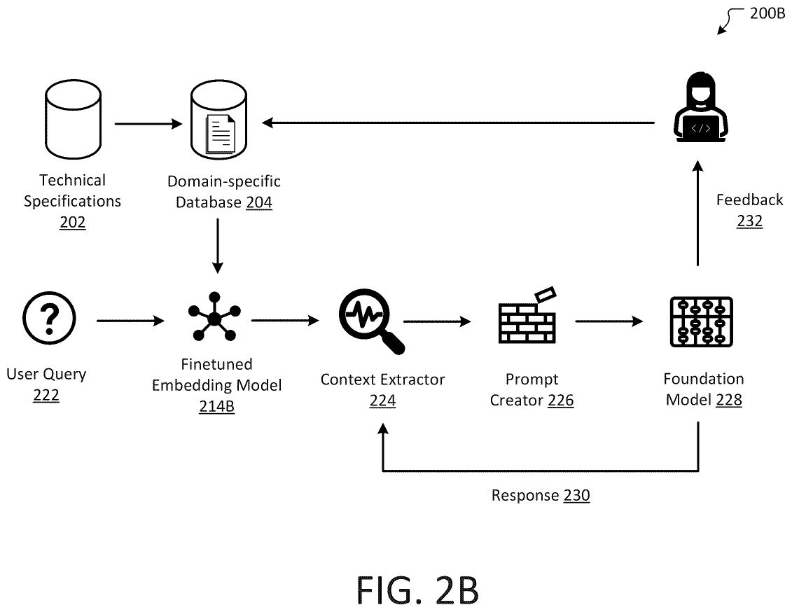

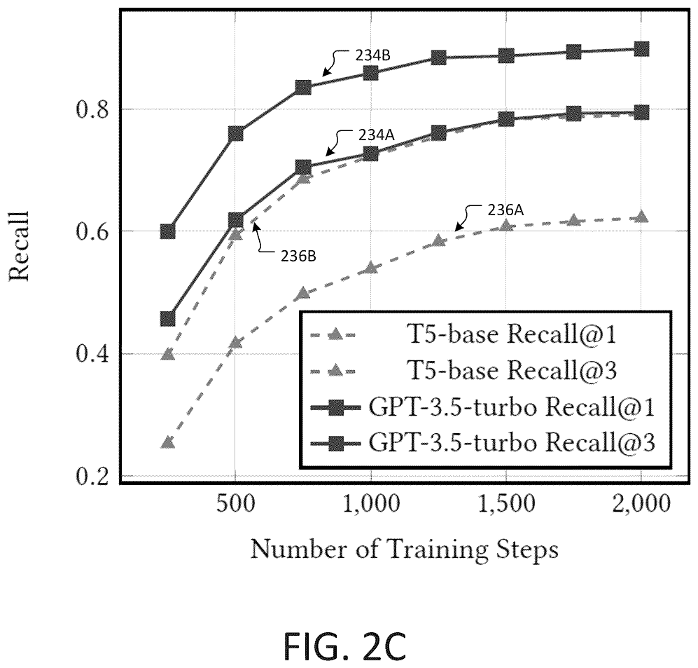

FIG. 2A illustrates an overview of an example conceptual architecture 200A for finetuning an embedding model to better recognize semantic similarities in domain-specific text, according to aspects described herein.

As illustrated by FIG. 2A, technical specifications database 202 may include public and/or private technical specifications for a specialized domain, such as a cloud RAN. For example, the technical specifications may include but are not limited to 3GPP specifications, WiFi standards, Open Radio Access Network (O-RAN) specifications, proprietary cloud service-provider documentation, and the like. These technical specifications may include thousands of documents, which may include domain-specific acronyms and/or terminology related to the telco domain. In other aspects, technical specifications database 202 may include documents and specifications particular to other specialized domains, such as chemical, biomedical, engineering, governmental, and the like.

The technical specifications database 202 may be utilized to build a domain-specific database 204 for a particular public or private domain. Since LLMs have strict limits on input size, the content contained in the technical specifications database 202 may be segmented into content segments 206 when building the domain-specific database 204. To preserve coherence and meaning of domain-specific text, appropriately sized segments or “chunks” of content may be determined by splitting technical specifications along section boundaries, e.g., using docx2txt library tools. Within each section, the text may be recursively split into samples that are “at most” n_words in length but without a hard constraint of “exactly” n_words. By splitting the technical specifications into reasonable-length content segments 206, while respecting section, paragraph, and sentence boundaries, each content segment 206 is designed to be: (1) coherent and non-arbitrary, and (2) representative of the domain-specific context as a whole.

Many LLMs are based on a transformer architecture, which uses input embeddings to represent words as numbers that the model can understand. As described further with reference to FIGS. 5A-5B, an encoder processes the input text and generates hidden states that capture its meaning and context, while a decoder generates the output sequence based on the encoded input sequence. Both input and output embeddings go through positional encoding, which helps the model understand the order of words in a sentence. During training, the model learns to generate these embeddings and guess the next word by looking at the words before it. Multiple layers of encoders and decoders are used in the transformer to improve performance on various natural language processing tasks such as language translation and conversational agents. Thus, when building domain-specific database 204, the text of each content segment 206 may be tokenized and converted to a word embedding vector for consumption by an LLM. For example, embedding model 214A (e.g., sentence-BERT all-MiniLM-L6-v2 embedding model) may be used to transform each of the content segments 206 into word embedding vectors. The resulting vector representation for each content segment 206 may be stored in an index of the domain-specific database 204 for efficient querying. In aspects, creating and storing word embeddings for each content segment 206 may be performed prior to receiving a user query, e.g., offline or at a time other than runtime.

In addition to creating word embeddings of content segments 206, each content segment 206A-C may be fed into a ML model 208 (e.g., a foundation model or a T5-base model) to generate one or more questions 210. In aspects, a T5-base model may be specially trained on web search queries and related passages to perform the specific task of generating multiple questions from a text sample, whereas a foundation model may be generally trained based on a vast corpus of web data covering a broad range of topics and domains to perform a variety of tasks. Since the generated questions 210A-C are derived from content segments 206A-C, the corresponding Q/A pairs 212A-C are assigned high similarity scores (e.g., “1”) (e.g., “positive Q/A pairs 212”).

Each generated question 210 is then fed into embedding model 414A to transform the generated question 210 into a word embedding (e.g., vector). Content extractor 224 then compares the word embedding of the generated question 210A to the word embeddings of each content segment 206 to determine the most relevant (“top-K”) content segments 216 based on semantic similarity (e.g., based on the distance between corresponding word embeddings). The top-K content segments 216 may include the top-3 content segments 216, the top-5 content segments 216, or the top-10 content segments 216, for example. If the source content segment 206A corresponding to the generated question 210A is returned in the top-K content segments 216, it is assigned a high similarity score (e.g., “1”) and together with generated question 210A is labeled as a positive Q/A pair 212A. The remaining top-K content segments 216 are assigned low similarity scores (e.g., “0”) and together with generated question 210A are labeled as negative Q/A pairs 218. Pseudo-labeled Q/A pairs 220 (including both positive Q/A pairs 212 and negative Q/A pairs 218, as determined for each generated question 210) are used to finetune embedding model 414A, resulting in finetuned embedding model 414B. By finetuning an existing embedding model (e.g., embedding model 414A), the embedding model recognizes semantic similarities associated with regular language as well as semantic similarities within a specialized domain, such as the telco domain.

FIG. 2B illustrates an overview of an example conceptual architecture for using one or more ML models to increase answer accuracy for domain-specific queries, according to aspects described herein.

Similar to FIG. 2A above, technical specifications database 202 may include public and/or private technical specifications for a specialized domain, such as a cloud RAN. For example, the technical specifications may include but are not limited to 3GPP specifications, WiFi standards, Open Radio Access Network (O-RAN) specifications, proprietary cloud service-provider documentation, and the like. In other aspects, technical specifications database 202 may include documents and specifications particular to other specialized domains, such as chemical, biomedical, engineering, governmental, and the like.

As noted above, technical specifications database 202 may be utilized to build a domain-specific database 204 for a particular public or private domain. For example, the content contained in technical specifications database 202 may be segmented into content segments (e.g., content segments 206 of FIG. 2A) when building the domain-specific database 204. By splitting the technical specifications into reasonable-length content segments, while respecting section, paragraph, and sentence boundaries, each content segment is designed to be: (1) coherent and non-arbitrary, and (2) representative of the domain-specific context as a whole. Additionally, when building domain-specific database 204, the text of each content segment may be tokenized and converted to a word embedding vector for consumption by an LLM. For example, finetuned embedding model 214B (FIG. 2A) may be used to transform each of the content segments into word embedding vectors and the resulting vector representation for each content segment may be stored in an index of the domain-specific database 204.

In other aspects, the domain-specific database 204 may be, or may be used to create, a semantic memory store of semantic embeddings (also referred to herein as “semantic addresses”) corresponding to one or more context objects associated with foundation model 228. In examples, an entry in a semantic memory store includes one or more semantic embeddings corresponding to a context object itself or a reference to the context object, among other examples. In examples, a semantic memory store stores embeddings that are associated with one or more foundation models and their specific versions, which may thus represent the same or similar context but in varying semantic embedding spaces (e.g., as is associated with each model/version). Further, when a new model is added or an existing model is updated, one or more entries within the semantic memory store may be reencoded (e.g., by generating a new semantic embedding according to the new embedding space). For example, response 230 and/or feedback 232 may cause entries within the semantic memory store to be reencoded. In this manner, a single context object entry within the semantic memory store may have a locatable semantic address across models/versions, thereby enabling retrieval of context objects based on a similarity determination (e.g., as a result of an algorithmic comparison) between a corresponding semantic address and a semantic context indication.

As illustrated by FIG. 2B, a user query 222 (e.g., domain-specific query) may be received by finetuned embedding model 214B. For example, user query 222 may involve unique terminologies, acronyms, and/or specialized jargon associated with a niche domain, such as the 5G telecommunications domain. Finetuned embedding model 214B may convert the user query 222 into a word embedding (e.g., vector). However, in this case, the finetuned embedding model is better able to incorporate domain-specific semantics into the word embedding. Content extractor 224 then compares the word embedding of the user query 222 to the word embeddings of each content segment (also generated by finetuned embedding model 214B) in the domain-specific database 204 to determine the most relevant (“top-K”) content segments based on a similarity metric (e.g., cosine similarity, L-distance, etc.). For example, cosine similarity measures the angle between two vectors in a high-dimensional space. If two vectors are very similar, their cosine similarity will be close to 1. If they are very different, their cosine similarity will be close to 0.

Using the similarity metric, context extractor 224 can rank the content segments in the database according to their similarity to the user query 222. The “top-K” content segments may include the top-3 content segments, the top-5 content segments, or the top-10 content segments, for example. Content segments that are semantically close to the user query 222 are extracted from the domain-specific database 204 by content extractor 224 as supplemental context. The supplemental context is used by prompt creator 226 to generate a prompt to foundation model 228. For example, the prompt may be created based on a prompt template, including one or more fields, regions, and/or other parts that may be populated (e.g., with the user query and/or supplemental context), thereby generating the prompt. In some aspects, a size of the prompt may be limited based on input size limitations imposed by the particular foundation model 228.

In response to the prompt, foundation model 228 outputs a response 230 answering the user query 222. In some aspects, response 230 may be provided to context extractor 224, which may cause embeddings in the domain-specific database 204 (and/or a semantic memory store) to be updated, as described above. In this way, the disclosed technology overcomes deficiencies of foundation models in answering domain-specific queries by finetuning existing embedding models to recognize semantic similarities for niche domains.

FIG. 2C illustrates an overview of recall test results for identifying the correct source segment for a given domain-specific question as a function of the number of training (finetuning) steps, according to aspects described herein. FIG. 2C also illustrates the improved performance obtained by using a foundation model for question generation instead of a model trained on query-response pairs extracted from web data.

As illustrated by FIG. 2C, the sentence-BERT all-MiniLM-L6-v2 embedding model was finetuned over 500, 1000, 1500, and 2000 training steps. In this study, 10,000 content segments were randomly selected from segmented 3GPP specification text. In a first test, Q/A pairs were generated by GPT-3.5-turbo from the corpus of 10,000 random content segments. The GPT-generated questions were then fed into the embedding model and a context extractor to identify the top-1 and top-3 semantically similar content segments within the corpus. The percentage recall of the source content segment in the top-1 and top-3 results by the context extractor is charted in curves 234A-B, respectively. As illustrated, recall of the source content segment in both the top-1 and top-3 results improved as the number of finetuning training steps increased. For example, as illustrated by curve 234A, recall@1 increased from about 0.45 to 0.79 over 2000 training steps and recall@3, as illustrated by curve 234B, increased from about 0.60 to about 0.90 over 2000 training steps.

In a second test, Q/A pairs were generated by a specially trained question-generation model (T5-base model) from the corpus of 10,000 random content segments. The T5-generated questions were then fed into the embedding model and a context extractor to identify the top-1 and top-3 semantically similar content segments within the corpus. The percentage recall of the source content segment in the top-1 and top-3 results by the context extractor is charted in curves 236A-B, respectively. As illustrated, recall of the source content segment in both the top-1 and top-3 results improved as the number of finetuning training steps increased. For example, as illustrated by curve 236A, recall@1 increased from about 0.25 to 0.62 over 2000 training steps and recall@3, as illustrated by curve 236B, increased from about 0.40 to about 0.80 over 2000 training steps. Additionally, FIG. 2C shows that using a foundation model (e.g., GPT-3.5-turbo) to generate the Q/A pairs, rather than a model trained for a single task on a single dataset (e.g., a specially trained question-generation model such as T5-base), provided better recall.

As noted above, despite the usefulness of state-of-the-art foundation models, they often return irrelevant or inaccurate responses to many domain-specific queries. This deficiency is largely due to the fact that LLMs, and the underlying embedding models, are typically trained on a massive corpus of web data that covers a broad range of topics and domains. However, domain-specific queries, like those related to wireless communication specifications, often require specialized training data to capture the technical jargon and patterns that are unique to the domain. Such training data is not always readily accessible or frequently discussed in online forums. Moreover, while embedding models may be finetuned using annotated datasets, generating these datasets for niche and specialized domains is an extremely arduous, time-consuming, and expensive task. The present application overcomes these issues by implementing a generative pseudo labeling (GPL) approach to creating labeled data for finetuning an existing embedding model to recognize semantic similarities within a specialized domain while maintaining understanding of semantic similarities in regular language. In this way, the accuracy and relevance of foundation-model responses to domain-specific queries is substantially improved, as illustrated by FIG. 2C.

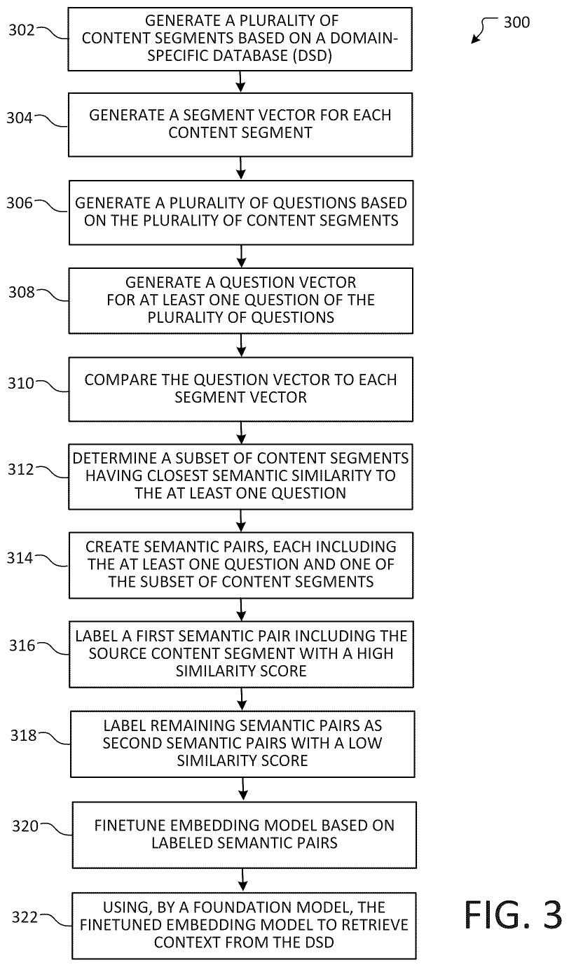

FIG. 3 illustrates an overview of an example method 300 for finetuning an embedding model, according to aspects described herein. In examples, aspects of method 300 are performed by embedding models (e.g., embedding models 214A-B of FIGS. 2A-2B), context extractors (e.g., context extractor 224 of FIGS. 2A-2B), prompt creators (e.g., prompt creator 226 of FIG. 2B), ML models (e.g., ML model 208 of FIG. 2A) and foundation models (e.g., foundation model 228 of FIG. 2B), among other examples.

As illustrated, method 300 begins at generate segments operation 302, where a plurality of content segments is generated based on a domain-specific database. In aspects, the domain-specific database may include public and/or private technical specifications for a specialized domain, such as a cloud RAN. For example, the technical specifications may include but are not limited to 3GPP specifications, WiFi standards, Open Radio Access Network (O-RAN) specifications, proprietary cloud service-provider documentation, and the like. These technical specifications may include thousands of documents, which may include domain-specific acronyms and/or terminology related to the telco domain. In other aspects, the technical specifications may include documents and specifications particular to other specialized domains, such as chemical, biomedical, engineering, governmental, and the like.

When the domain-specific database is segmented into a plurality of content segments (e.g., content segments 206 of FIG. 2A), to preserve coherence and meaning of domain-specific text, appropriately sized segments or “chunks” of content may be determined by splitting technical specifications along section boundaries, e.g., using docx2txt library tools. Within each section, the text may be recursively split into samples that are “at most” n_words in length but without a hard constraint of “exactly” n_words. By splitting the technical specifications into reasonable-length content segments, while respecting section, paragraph, and sentence boundaries, each content segment is designed to be: (1) coherent and non-arbitrary, and (2) representative of the domain-specific context as a whole.

At generate vector operation 304, a segment vector may be generated for each content segment. As described above, many LLMs are based on a transformer architecture, which uses input embeddings to represent words as numbers that the model can understand. As described further with respect to FIGS. 5A-5B, an encoder processes the input text and generates hidden states that capture its meaning and context, while a decoder generates the output sequence based on the encoded input sequence. Both input and output embeddings go through positional encoding, which helps the model understand the order of words in a sentence. During training, the model learns to generate these embeddings and guess the next word by looking at the words before it. Multiple layers of encoders and decoders are used in the transformer to improve performance on various natural language processing tasks such as language translation and conversational agents. Thus, at generate operation 304, the text of each content segment may be tokenized and converted to a word embedding (e.g., segment vector) for consumption by an LLM. For example, an embedding model (e.g., sentence-BERT all-MiniLM-L6-v2 embedding model) may be used to transform each of the content segments into segment vectors. The resulting segment vector representation for each content segment may be stored in an index of the domain-specific database for efficient querying. In aspects, creating and storing segment vectors for each content segment may be performed prior to receiving a user query, e.g., offline or at a time other than runtime.

At generate questions operation 306, a plurality of questions may be generated based on the plurality of content segments. For example, each content segment may be fed into a ML model (e.g., a foundation model or a specially trained question-generation model) to generate one or more questions. In aspects, a T5-base model may be specially trained on web search queries and related passages to perform the specific task of generating multiple questions from a text sample, whereas a foundation model may be generally trained based on a vast corpus of web data covering a broad range of topics and domains to perform a variety of generalized tasks. In aspects, each question of the plurality of questions is derived (or generated) from a source content segment of the plurality of content segments.

At generate vector operation 308, a question vector may be generated for each question of the plurality of questions. For example, the embedding model (e.g., sentence-BERT all-MiniLM-L6-v2 embedding model) may be used to transform at least one question of the plurality of questions into a question vector.

At compare operation 310, the question vector of the at least one question is compared to each segment vector of the plurality of content segments based on a similarity metric (e.g., cosine similarity, L-distance, etc.). In aspects, cosine similarity measures the angle between two vectors in a high-dimensional space. If two vectors are very similar, their cosine similarity will be close to 1. If they are very different, their cosine similarity will be close to 0.

At determine operation 312, based on the similarity metric, the content segments may be ranked according to their similarity to the at least one question. The “top-K” subset of content segments having the closest similarity to the at least one question may include the top-1 content segments, top-3 content segments, top-5 content segments, or the top-10 content segments, for example.

At create operation 314, a plurality of semantic pairs (or question/answer (Q/A) pairs) are created based on the at least one question and the subset of content segments. In aspects, each semantic pair of the plurality of semantic pairs includes the at least one question and one of the subset of content segments.

At label operation 316, a first semantic pair which includes the source content segment used to generate the at least one question is labeled with a high similarity score (e.g., “1”) and designated as a “positive” semantic pair. In this way, the positive semantic pair is biased towards semantic similarity.

At label operation 318, the remaining semantic pairs (e.g., second semantic pairs) of the plurality of semantic pairs are labeled with a low similarity score (e.g., “0”) and designated as “negative” semantic pairs. In this way, the negative semantic pairs are biased away from semantic similarity. In some aspects, rather than labeling the second semantic pairs with a similarity score of “0,” the remaining semantic pairs may be evaluated based on their relative semantic similarity to the at least one question. For example, a foundation model may be used to “rank” or “grade” the remaining semantic pairs with respect to one another. In this case, the remaining semantic pairs may be assigned low similarity scores greater than “0” but less than “1.”

At finetuning operation 320, an embedding model (e.g., the same embedding model that generated the segment and question vectors above) may be finetuned using the labeled first semantic pair and the labeled second semantic pair(s). In aspects, in order to recognize semantic similarities, an embedding model is trained based on both high similarity (e.g., positive) and low similarity (e.g., negative) semantic pairs. Thus, the present application achieves such finetuning based on a generative pseudo labeling (GPL) approach in which positive and negative semantic pairs are created from a domain-specific database. In this way, the embedding model is better able to recognize semantic similarities specific to a specialized domain, such as a telco domain.

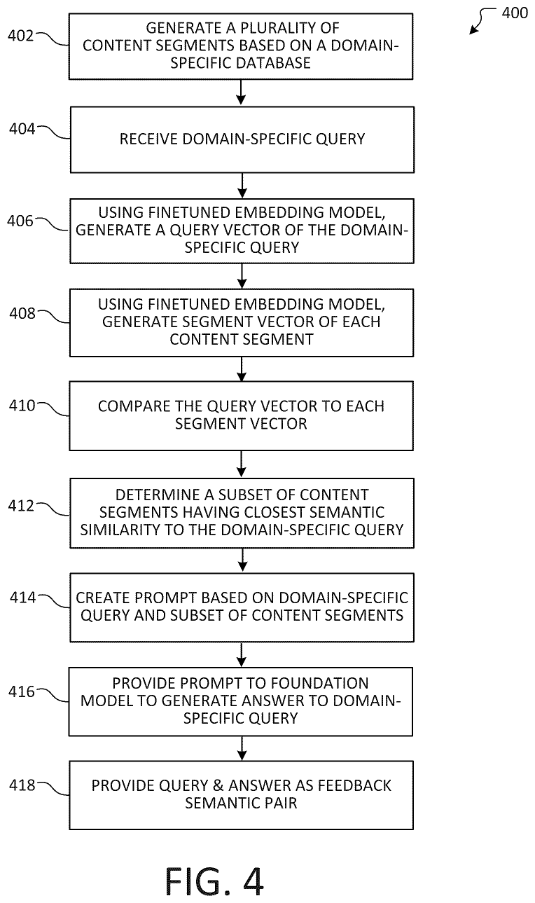

At using operation 322, the finetuned embedding model is used by a foundation model to retrieve context from the domain-specific database to answer a domain-specific user query, as will be described further with respect to FIG. 4.

As should be appreciated, operations 302-322 are described for purposes of illustrating the present methods and systems and are not intended to limit the disclosure to a particular sequence of steps, e.g., operations may be performed in a different order and more or fewer operations may be performed without departing from the present disclosure.

FIG. 4 illustrates an overview of an example method 400 for using a foundation model to output an answer to a domain-specific query, according to aspects described herein. In examples, aspects of method 400 are performed by finetuned embedding models (e.g., finetuned embedding model 214B of FIGS. 2A-2B), context extractors (e.g., context extractor 224 of FIGS. 2A-2B), prompt creators (e.g., prompt creator 226 of FIG. 2B), ML models (e.g., ML model 208 of FIG. 2A) and foundation models (e.g., foundation model 228 of FIG. 2B), among other examples.

As illustrated, method 400 begins at generate segments operation 302, where a plurality of content segments is generated based on a domain-specific database. In aspects, the domain-specific database may include public and/or private technical specifications for a specialized domain, such as a cloud RAN. For example, the technical specifications may include but are not limited to 3GPP specifications, WiFi standards, Open Radio Access Network (O-RAN) specifications, proprietary cloud service-provider documentation, and the like. When the domain-specific database is segmented into a plurality of content segments (e.g., content segments 206 of FIG. 2A), to preserve coherence and meaning of domain-specific text, appropriately sized segments or “chunks” of content may be determined by splitting technical specifications along section boundaries, e.g., using docx2txt library tools. By splitting the technical specifications into reasonable-length content segments, while respecting section, paragraph, and sentence boundaries, each content segment is designed to be: (1) coherent and non-arbitrary, and (2) representative of the domain-specific context as a whole.

At receive operation 404, a domain-specific query is received. For example, the domain-specific query may be a natural language (NL) query from an operator managing MEC systems for a cloud RAN. The domain-specific query may further involve unique terminologies, acronyms, and/or specialized jargon associated with the 5G telecommunications domain.

At generate vector operation 406, using a finetuned embedding model, a query vector may be generated for the domain-specific query. As described above, many LLMs are based on a transformer architecture, which uses input embeddings to represent words as numbers that the model can understand. However, LLMs often return irrelevant or inaccurate responses to many domain-specific queries because LLMs, and their underlying embedding models, are typically trained on a massive corpus of web data covering a broad range of topics and domains. Accordingly, domain-specific queries, like those related to wireless communication specifications, often require specialized training data to capture the technical jargon and patterns that are unique to the domain. Such training data is not always readily accessible or frequently discussed in online forums. Moreover, while embedding models may be finetuned using annotated datasets, generating these datasets for niche and specialized domains is an extremely arduous, time-consuming, and expensive task. The present application overcomes these issues by implementing a generative pseudo labeling (GPL) approach to creating labeled data for finetuning an existing embedding model to recognize semantic similarities within a specialized domain. In this way, the accuracy and relevance of foundation-model responses to domain-specific queries is substantially improved. Thus, at generate vector operation 406, the text of the domain-specific query may be tokenized by a finetuned embedding model (e.g., finetune sentence-BERT all-MiniLM-L6-v2 embedding model) to transform the domain-specific query into a query vector for consumption by an LLM. In aspects, the finetuned embedding model is able to incorporate domain-specific semantics into the generated query vector.

Similarly, at generate vector operation 408, using the finetuned embedding model, a segment vector may be generated for each content segment of the domain-specific database. For example, the text of each content segment may be tokenized and converted to a word embedding (e.g., segment vector) by the finetuned embedding model (e.g., sentence-BERT all-MiniLM-L6-v2 embedding model) for consumption by an LLM. As noted above, the finetuned embedding model may incorporate domain-specific semantics into the segment vector of each content segment. The resulting segment vector representation for each content segment may be stored in an index of the domain-specific database for efficient querying. In aspects, creating and storing segment vectors for each content segment may be performed prior to receiving the domain-specific query, e.g., offline or at a time other than runtime.

At compare operation 410, the query vector for the domain-specific query is compared to each segment vector of the plurality of content segments based on a similarity metric (e.g., cosine similarity, L-distance, etc.). For example, cosine similarity measures the angle between two vectors in a high-dimensional space. If two vectors are very similar, their cosine similarity will be close to 1. If they are very different, their cosine similarity will be close to 0.

At determine operation 412, based on the similarity metric, the content segments may be ranked (e.g., by a context extractor) according to their similarity to the domain-specific query. The “top-K” subset of content segments having the closest similarity to the domain-specific query may include the top-1 content segments, top-3 content segments, top-5 content segments, the top-10 content segments, and the like.

At create operation 414, a prompt may be created based on the domain-specific query and the top-K subset of content segments. In some aspects, the subset of content segments may be compiled or appended to the domain-specific query to create the prompt. In other aspects, the prompt may be created based on a prompt template, including one or more fields, regions, and/or other parts that may be populated (e.g., with the domain-specific query and/or subset of content segments), thereby generating the prompt. In some examples, a size of the prompt may be limited based on input size limitations imposed by a particular foundation model.

At provide operation 416, the prompt may be fed to a foundation model to return an answer to the domain-specific query. In aspects, since the supplemental context (e.g., the subset of content segments) was identified based on semantic similarities specific to a specialized domain, the supplemental context is better able to inform the foundation model of the unique terminologies, acronyms, and/or jargon of the specialize domain. In this way, the foundation model is able to generate a more accurate and relevant answer to the domain-specific query.

At provide operation 418, the domain-specific query and the answer generated by the foundation model may form a feedback semantic pair, which is provided as feedback to the system. The feedback semantic pair may be evaluated and/or annotated by experts, stored in the domain-specific database, and/or used to further finetune the embedding model. In this way, the ability of the embedding model to recognize domain-specific semantics may be continually improved, thereby improving the ability of a foundation model to respond to domain-specific queries for a specialized domain, such as the telco domain.

As should be appreciated, operations 402-418 are described for purposes of illustrating the present methods and systems and are not intended to limit the disclosure to a particular sequence of steps, e.g., operations may be performed in a different order and more or fewer operations may be performed without departing from the present disclosure.

FIGS. 5A and 5B illustrate overviews of an example generative machine learning model that may be used according to aspects described herein. With reference first to FIG. 5A, conceptual diagram 500 depicts an overview of pre-trained generative model package 504 that processes a query input 502 and, for example, a prompt, to generate output 506 associated with generating answers to domain-specific queries, according to aspects described herein. Examples of pre-trained generative model package 504 include, but are not limited to, Megatron-Turing Natural Language Generation model (MT-NLG), Generative Pre-trained Transformer 3 (GPT-3), Generative Pre-trained Transformer 3.5 turbo (GPT-3.5-turbo), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 504 is pre-trained according to a variety of inputs (e.g., a variety of human languages, a variety of programming languages, and/or a variety of content types) and therefore need not be finetuned or trained for a specific scenario. Rather, generative model package 504 may be more generally pre-trained, such that query input 502 includes a prompt that is generated, selected, or otherwise engineered to induce generative model package 504 to produce certain generative output 506. For example, a prompt includes context and/or one or more completion prefixes that thus preload generative model package 504 accordingly. As a result, generative model package 504 is induced to generate output based on the prompt that includes a predicted sequence of tokens (e.g., up to a token limit of generative model package 504) relating to the prompt. In examples, the predicted sequence of tokens is further processed (e.g., by output decoding 516) to yield generative output 506. For instance, each token is processed to identify a corresponding word, word fragment, or other content that forms at least a part of generative output 506. It will be appreciated that query input 502 and generative output 506 may each include any of a variety of content types, including, but not limited to, text output, image output, audio output, video output, programmatic output, and/or binary output, among other examples. In examples, query input 502 and generative output 506 may have different content types, as may be the case when generative model package 504 includes a generative multimodal machine learning model.

As such, generative model package 504 may be used in any of a variety of scenarios and, further, a different generative model package may be used in place of generative model package 504 without substantially modifying other associated aspects (e.g., similar to those described herein with respect to FIGS. 1, 2A-2C, 3, and 4). Accordingly, generative model package 504 operates as a tool with which machine learning processing is performed, in which certain inputs to generative model package 504 are programmatically generated or otherwise determined, thereby causing generative model package 504 to produce generative output 506 that may subsequently be used for further processing.

Generative model package 504 may be provided or otherwise used according to any of a variety of paradigms. For example, generative model package 504 may be used local to a computing device (e.g., on-prem edge servers 116A-B, network edge servers 134, or cloud servers 154) or may be accessed remotely from a machine learning service. In other examples, aspects of generative model package 504 are distributed across multiple computing devices. In some instances, generative model package 504 is accessible via an application programming interface (API), as may be provided by an operating system of a computing device and/or by the machine learning service, among other examples.

With reference now to the illustrated aspects of generative model package 504, generative model package 504 includes input tokenization 508, input embedding 510, model layers 512, output layer 514, and output decoding 516. In examples, input tokenization 508 processes query input 502 to generate input embedding 510, which includes a sequence of symbol representations that corresponds to query input 502. Accordingly, input embedding 510 is processed by model layers 512, output layer 514, and output decoding 516 to produce generative output 506. An example architecture corresponding to generative model package 504 is depicted in FIG. 5B, which is discussed below in further detail. Even so, it will be appreciated that the architectures that are illustrated and described herein are not to be taken in a limiting sense and, in other examples, any of a variety of other architectures may be used.

FIG. 5B is a conceptual diagram that depicts an example architecture 550 of a pre-trained generative machine learning model that may be used according to aspects described herein. As noted above, any of a variety of alternative architectures and corresponding ML models may be used in other examples without departing from the aspects described herein.

As illustrated, architecture 550 processes query input 502 to produce generative output 506, aspects of which were discussed above with respect to FIG. 5A. Architecture 550 is depicted as a transformer model that includes encoder 552 and decoder 554. Encoder 552 processes input embedding 558 (aspects of which may be similar to input embedding 510 in FIG. 5A), which includes a sequence of symbol representations that corresponds to input 556. In examples, input 556 includes query input 502 and a prompt, aspects of which may be similar to user query 222, context extracted from a domain-specific database or a semantic memory store, and/or a prompt that was generated based on a prompt template of a library according to aspects described herein.

Further, positional encoding 560 may introduce information about the relative and/or absolute position for tokens of input embedding 558. Similarly, output embedding 574 includes a sequence of symbol representations that correspond to output 572, while positional encoding 576 may similarly introduce information about the relative and/or absolute position for tokens of output embedding 574.

As illustrated, encoder 552 includes example layer 570. It will be appreciated that any number of such layers may be used, and that the depicted architecture is simplified for illustrative purposes. Example layer 570 includes two sub-layers: multi-head attention layer 562 and feed forward layer 566. In examples, a residual connection is included around each layer 562, 566, after which normalization layers 564 and 568, respectively, are included.

Decoder 554 includes example layer 590. Similar to encoder 552, any number of such layers may be used in other examples, and the depicted architecture of decoder 554 is simplified for illustrative purposes. As illustrated, example layer 590 includes three sub-layers: masked multi-head attention layer 578, multi-head attention layer 582, and feed forward layer 586. Aspects of multi-head attention layer 582 and feed forward layer 586 may be similar to those discussed above with respect to multi-head attention layer 562 and feed forward layer 566, respectively. Additionally, masked multi-head attention layer 578 performs multi-head attention over the output of encoder 552 (e.g., output 572). In examples, masked multi-head attention layer 578 prevents positions from attending to subsequent positions. Such masking, combined with offsetting the embeddings (e.g., by one position, as illustrated by multi-head attention layer 582), may ensure that a prediction for a given position depends on known output for one or more positions that are less than the given position. As illustrated, residual connections are also included around layers 578, 582, and 586, after which normalization layers 580, 584, and 588, respectively, are included.

Multi-head attention layers 562, 578, and 582 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 5B (e.g., by a corresponding normalization layer 564, 580, or 584).

Feed forward layers 566 and 586 may each be a fully connected feed-forward network, which applies to each position. In examples, feed forward layers 566 and 586 each include a plurality of linear transformations with a rectified linear unit activation in between. In examples, each linear transformation is the same across different positions, while different parameters may be used as compared to other linear transformations of the feed-forward network.

Additionally, aspects of linear transformation 592 may be similar to the linear transformations discussed above with respect to multi-head attention layers 562, 578, and 582, as well as feed forward layers 566 and 586. Softmax 594 may further convert the output of linear transformation 592 to predicted next-token probabilities, as indicated by output probabilities 596. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 504 in FIG. 5A or encoder 552 and decoder 554 in FIG. 5B) to generate a series of output tokens (e.g., words), for example which are then combined to yield a complete sentence (and/or any of a variety of other content). It will be appreciated that other generative models may generate multiple output tokens in a single iteration and may thus used a reduced number of iterations or a single iteration.

Accordingly, output probabilities 596 may thus form generative output 506 according to aspects described herein, such that the output of the generative ML model (e.g., which may include structured output) is used as input for subsequent processing according to aspects described herein. In other examples, generative output 506 is provided as generated output after processing query input (e.g., similar to aspects of operation 416 of FIG. 4), which may further be processed according to the disclosed aspects.

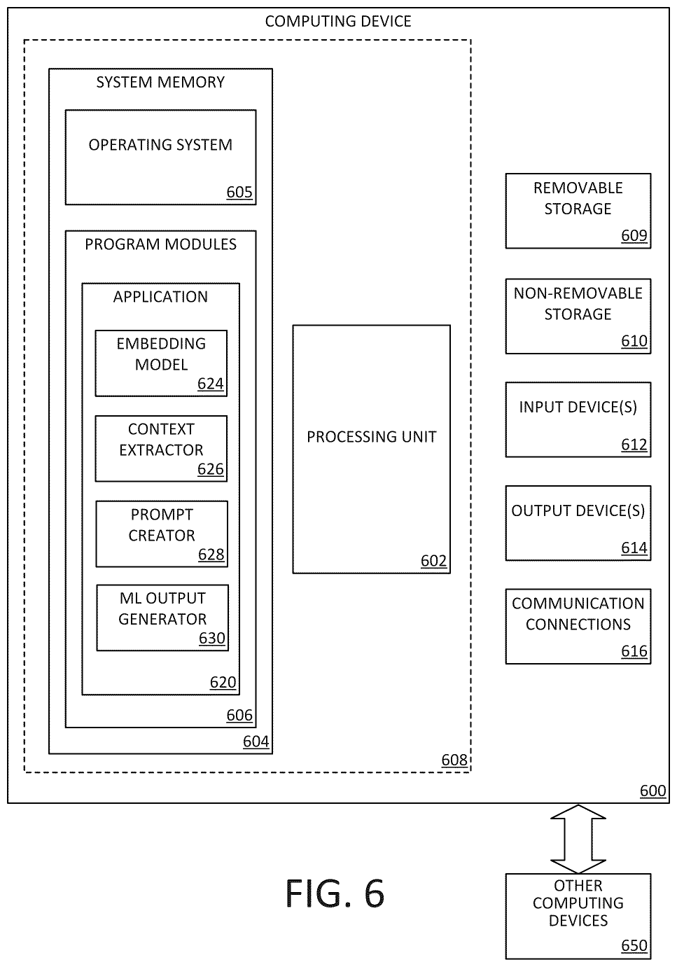

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including one or more devices associated with a machine learning service, as well as computing devices (e.g., on-prem edge servers 116A-B, network edge servers 134, and/or cloud servers 154) discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, an application 620 (e.g., service application) may run various modules to perform functionalities described herein, such as an embedding model 624, context extractor 626, a prompt creator 628, an/or a ML output generator 630. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include metric monitors, definition databases, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

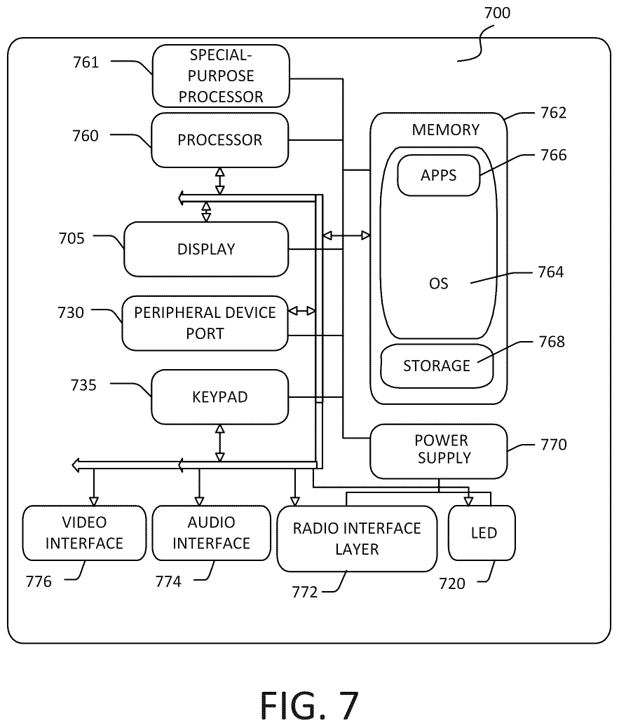

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

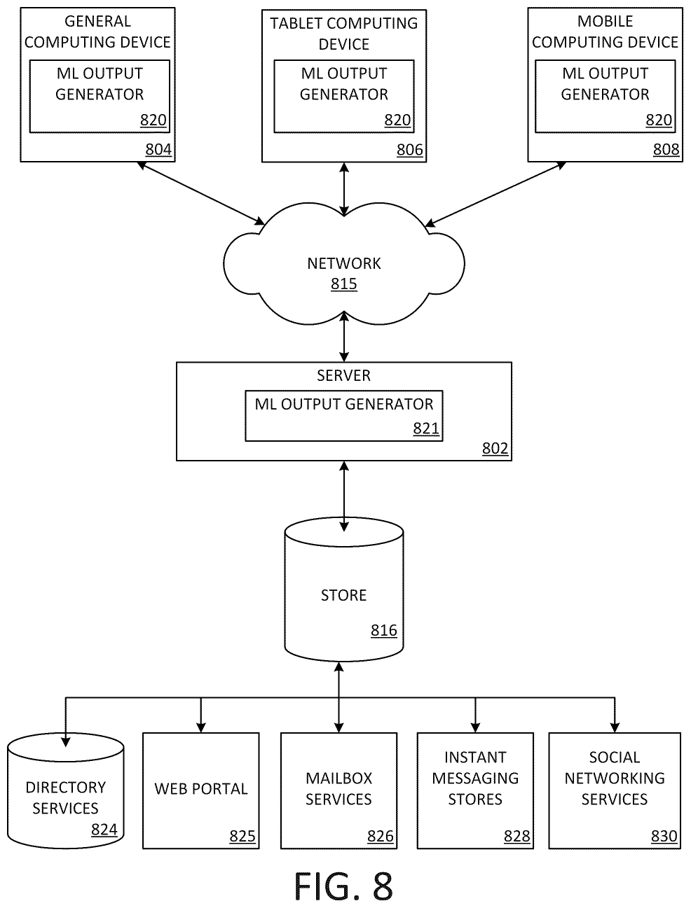

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

A ML output generator 820 (e.g., similar to application 620) may be employed by a client that communicates with server device 802. Additionally, or alternatively, ML output generator 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, cause the system to perform a set of operations to finetune an embedding model for a network domain. The set of operations includes generating a plurality of content segments based on a network-specific database and generating a plurality of questions based on the plurality of content segments, where each question of the plurality of questions corresponds to a source content segment of the plurality of content segments. The set of operations further includes determining a subset of the plurality of content segments having a closest semantic similarity to at least one question of the plurality of questions and creating a plurality of semantic pairs, where each semantic pair includes the at least one question and one content segment of the subset of content segments. Additionally, the set of operations includes labeling a first semantic pair with a high similarity score, where the first semantic pair includes the source content segment corresponding to the at least one question, and labeling at least one remaining semantic pair of the plurality of semantic pairs as a second semantic pair with a low similarity score. The set of operations also includes finetuning an embedding model using the labeled first semantic pair and the labeled second semantic pair. Additionally, the set of operations includes using, by a foundation model, the finetuned embedding model to retrieve context from the network-specific database to answer a network-specific user query.

In further aspects, the plurality of questions is generated by a machine-learning (ML) model and, further, the ML model is one of a foundation model or a specially trained question-generation model. Additionally, where determining the subset of content segments having closest semantic similarity to the at least one question is performed using a cosine similarity metric. In further aspects, the network-specific database is associated with a 5G multi-access edge computing system. Still further, the labeled first semantic pair is biased towards semantic similarity and the labeled second semantic pair is biased away from semantic similarity. In yet further aspects, the set of operations includes generating a segment vector for each content segment of the plurality of content segments, generating a question vector for the at least one question and, based on comparing the question vector to each segment vector, determining the subset of content segments having the closest semantic similarity to the at least one question. Additionally, where generating the question vector and each segment vector is performed by the embedding model. Still further, where the subset of content segments comprises top-K content segments having the closest semantic similarity to the at least one question.

In another aspect, a method of using a finetuned embedding model to respond to a domain-specific query is provided. The method includes generating a plurality of content segments based on a domain-specific database and receiving a domain-specific query. Additionally, the method includes using a finetuned embedding model, creating a query vector representing the domain-specific query and using the finetuned embedding model, creating a segment vector representing each content segment of the plurality of content segments. Based on comparing the query vector to each segment vector, the method also includes determining a subset of the plurality of content segments having a closest semantic similarity to the domain-specific query and creating a prompt based on the domain-specific query and the subset of content segments. Using a foundation model, the method includes generating an answer to the domain-specific query based on the prompt.

In further aspects, the finetuned embedding model is trained based on pseudo-labeled semantic pairs generated based on the plurality of content segments. Still further, the finetuned embedding model recognizes semantic similarities unique to a specialized domain associated with the domain-specific query. Additionally, the specialized domain is a telecommunications domain. Yet further, the specialized domain is a 5G multi-access edge computing domain. In further aspects of the method, the answer is relevant to the specialized domain. Additionally, providing the answer and the domain-specific query as feedback to the embedding model.

In yet another aspect, a method of finetuning an embedding model for a specialized domain is provided. The method includes generating a plurality of content segments based on a domain-specific database associated with the specialized domain and generating a plurality of questions based on the plurality of content segments, where each question of the plurality of questions corresponds to a source content segment of the plurality of content segments. Using an embedding model, the method includes generating a segment vector for each content segment of the plurality of content segments and generating a question vector for at least one question of the plurality of questions. Based on comparing the question vector to each segment vector, the method includes determining a subset of the plurality of content segments having a closest semantic similarity to the at least one question and creating a plurality of question/answer (Q/A) pairs, where each Q/A pair includes the at least one question and one content segment of the subset of content segments. In further aspects, the method includes labeling a first Q/A pair with a high similarity score, where the first Q/A pair includes the source content segment corresponding to the at least one question, and labeling at least one remaining Q/A pair of the plurality of Q/A pairs as a second Q/A pair with a low similarity score. Additionally, the method includes finetuning the embedding model based on the labeled first Q/A pair and the labeled second Q/A pair. Additionally, the specialized domain is a 5G network domain. In further aspects, the labeled first Q/A pair is a positive Q/A pair and the labeled second Q/A pair is a negative Q/A pair. Additionally, the finetuned embedding model is utilized to provide context to a foundation model for returning answers to domain-specific queries.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations to finetune an embedding model for a network domain, the set of operations comprising:
generating a plurality of content segments based on a network-specific database;
generating a plurality of questions based on the plurality of content segments, wherein each question of the plurality of questions corresponds to a source content segment of the plurality of content segments;
determining a subset of the plurality of content segments having a closest semantic similarity to at least one question of the plurality of questions;
creating a plurality of semantic pairs, wherein each semantic pair includes the at least one question and one content segment of the subset of content segments;
labeling a first semantic pair with a high similarity score, wherein the first semantic pair includes the source content segment corresponding to the at least one question;
labeling at least one remaining semantic pair of the plurality of semantic pairs as a second semantic pair with a low similarity score;
finetuning an embedding model using the labeled first semantic pair and the labeled second semantic pair; and
using, by a foundation model, the finetuned embedding model to retrieve context from the network-specific database to answer a network-specific user query.

2. The system of claim 1, wherein the plurality of questions is generated by a machine-learning (ML) model.

3. The system of claim 2, wherein the ML model is one of a foundation model or a specially trained question-generation model.

4. The system of claim 1, wherein determining the subset of content segments having closest semantic similarity to the at least one question is performed using a cosine similarity metric.

5. The system of claim 1, wherein the network-specific database is associated with a 5G multi-access edge computing system.

6. The system of claim 1, wherein the labeled first semantic pair is biased towards semantic similarity, and wherein the labeled second semantic pair is biased away from semantic similarity.

7. The system of claim 1, the set of operations further comprising:
generating a segment vector for each content segment of the plurality of content segments;
generating a question vector for the at least one question; and
based on comparing the question vector to each segment vector, determining the subset of content segments having the closest semantic similarity to the at least one question.

8. The system of claim 7, wherein generating the question vector and each segment vector is performed by the embedding model.

9. The system of claim 1, wherein the subset of content segments comprises top-K content segments having the closest semantic similarity to the at least one question.

10. A method of using a finetuned embedding model to respond to a domain-specific query, comprising:
generating a plurality of content segments based on a domain-specific database;
receiving a domain-specific query;
using a finetuned embedding model, creating a query vector representing the domain-specific query;
using the finetuned embedding model, creating a segment vector representing each content segment of the plurality of content segments;
based on comparing the query vector to each segment vector, determining a subset of the plurality of content segments having a closest semantic similarity to the domain-specific query;
creating a prompt based on the domain-specific query and the subset of content segments; and
using a foundation model, generating an answer to the domain-specific query based on the prompt.

11. The method of claim 10, wherein the finetuned embedding model is trained based on pseudo-labeled semantic pairs generated based on the plurality of content segments.

12. The method of claim 10, wherein the finetuned embedding model recognizes semantic similarities unique to a specialized domain associated with the domain-specific query.

13. The method of claim 12, wherein the specialized domain is a telecommunications domain.

14. The method of claim 12, wherein the specialized domain is a 5G multi-access edge computing domain.

15. The method of claim 10, providing the answer and the domain-specific query as feedback to the embedding model.

16. The method of claim 12, wherein the answer is relevant to the specialized domain.

17. A method of finetuning an embedding model for a specialized domain, comprising:
generating a plurality of content segments based on a domain-specific database associated with the specialized domain;
generating a plurality of questions based on the plurality of content segments, wherein each question of the plurality of questions corresponds to a source content segment of the plurality of content segments;
using an embedding model, generating a segment vector for each content segment of the plurality of content segments;
using the embedding model, generating a question vector for at least one question of the plurality of questions;
based on comparing the question vector to each segment vector, determining a subset of the plurality of content segments having a closest semantic similarity to the at least one question;
creating a plurality of question/answer (Q/A) pairs, wherein each Q/A pair includes the at least one question and one content segment of the subset of content segments;
labeling a first Q/A pair with a high similarity score, wherein the first Q/A pair includes the source content segment corresponding to the at least one question;
labeling at least one remaining Q/A pair of the plurality of Q/A pairs as a second Q/A pair with a low similarity score; and
finetuning the embedding model based on the labeled first Q/A pair and the labeled second Q/A pair.

18. The method of claim 17, wherein the specialized domain is a 5G network domain.

19. The method of claim 17, wherein the labeled first Q/A pair is a positive Q/A pair, and wherein the labeled second Q/A pair is a negative Q/A pair.

20. The method of claim 17, wherein the finetuned embedding model is utilized to provide context to a foundation model for returning answers to domain-specific queries.
